(19) United States
(12) Patent Application Publication
(10) Pub. No.: US 2004/0032791 A1
(43) Pub. Date: Feb. 19, 2004

(54) Portable blender system

(76) Inventor: Kurt Gauss, Spokane, WA (US)

Correspondence Address: WELLS ST. JOHN P.S., 601 W. FIRST AVENUE, SUITE 1300, SPOKANE, WA, 99201, US

(21) Appl. No.: 10/222,746

(22) Filed: Aug. 15, 2002

(51) Int. Cl. B01F 7/00

(52) U.S. Cl. 366/199; 366/205; 366/314

(57) ABSTRACT

A portable blender system which includes a container, a blender base, and preferably a hand crank mechanism for rotating the blade. The blender base is sized and configured relative to the container such that the blender base may be inserted into and stored within the container for more compact storage and transportation of the portable blender system.

### CROSS REFERENCE TO RELATED APPLICATION

There are no related applications.

### TECHNICAL FIELD

This invention generally pertains to a portable blender system, more particularly, a portable blender system in which the base of the blender may be placed within the container of the blender for more compact storage and transportation.

### BACKGROUND OF THE INVENTION

Blenders for mixing various items have been known for many years. Some of the original blenders were hand crank blenders, and eventually electric blenders were developed which utilize an electric motor to cause the rotation of the blade of the blender.

Most blenders are characterized by a large heavier base and a container. The base would contain the controls for the speed of the motor and consequently the speed of the blade.

One issue with a typical blender is the storage of the unit. Storing blenders is typically cumbersome, as the combination of the base and the container is very tall and it is difficult to find locations where the blender can be stored together as a unit. Instead, oftentimes the container is separated from the base and separately stored.

In many outdoor activities, it is desirable to bring a blender along, but the blender takes up more space than is necessary and is cumbersome to bring, for instance camping, boating, and other similar outdoor activities. Furthermore, while electric blenders are more convenient for the operator, they add more weight to the overall unit, and it may be therefore preferred in some applications to have a hand crank blender for weight and compactness reasons.

It is therefore an object of this invention to provide an improved portable blender system with a more compact way of storing and transporting the blender, wherein the base of the blender may be inserted into and stored within the container portion of the blender. This stored configuration results in a much more compact and easily transportable blender system.

### BRIEF DESCRIPTION OF THE DRAWINGS

Preferred embodiments of the invention are described below with reference to the following accompanying drawings.

FIG. 1 is a front elevation view of a portable blender system embodiment of this invention;

FIG. 2 is a side elevation view of an embodiment of a portable blender system contemplated by this invention;

FIG. 3 is an elevation view illustrating the insertion of the blender base into the container, as well as the lid fitting on the container;

FIG. 4 is an elevation view of an embodiment of this invention, wherein the blender base has been fully inserted into the container and the container lid placed on the container, thereby fully housing the base for storage and/or transportation;

FIG. 5 is an elevation view of an embodiment of the container which may be utilized in this invention;

FIG. 6 is a top view of the container illustrated in FIG. 5;

FIG. 7 is an illustration of one embodiment of a gearing system which may be utilized in a blender base as contemplated by this invention;

FIG. 8 is a side elevation view of the drive system illustrated in FIG. 7; and

FIG. 9 is an exploded view of an embodiment of a portable blender system contemplated by this invention.

### DETAILED DESCRIPTION OF THE PREFERRED EMBODIMENTS

Many of the fastening, connection, process and other means and components utilized in this invention are widely known and used in the field of the invention described, and their exact nature or type is not necessary for an understanding and use of the invention by a person skilled in the art or science, and they will not therefore be discussed in significant detail. Furthermore, the various components shown or described herein for any specific application of this invention can be varied or altered as anticipated by this invention and the practice of a specific application of any element may already be widely known or used in the art or by persons skilled in the art or science and each will not therefore be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

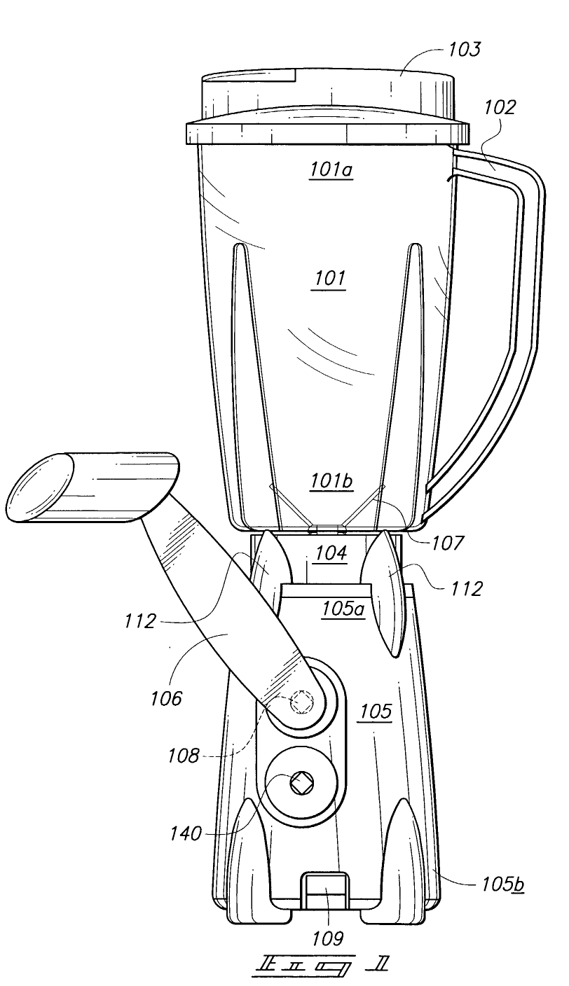

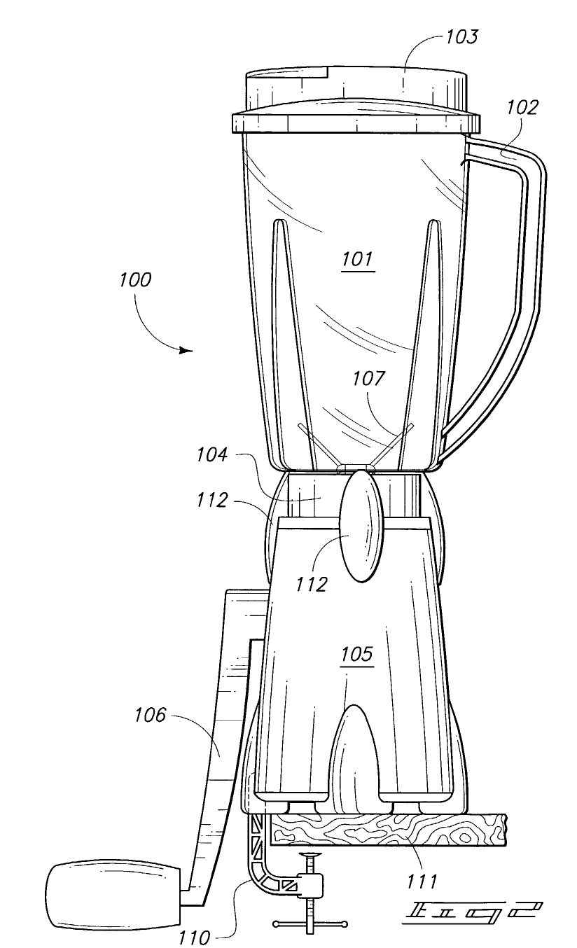

FIG. 1 illustrates a portable blender system, including container 101 or vessel with top end 101a and bottom end 101b, handle 102, container lid 103, blade 107, container bottom 104, blender base 105 with top end 105a and bottom end 105b, crank arm 106 which pivots about crank axis 108 for a first speed of rotation of blade 107, and crank axis 140 on which crank arm 106 may be placed to achieve a different blender or blade 107 speed. Aperture 109 may be used in combination with a clamp 110 (shown in FIG. 2) to help secure the blender system 100 to a table or other structure. FIG. 1 also shows side structures 112 attached to either blender base 105 or containment bottom 104 to provide structural or side support to locate and hold container 101 on blender base 105.

It should be noted and will be illustrated in later Figures that side structures 112 may also be utilized when the blender base 105 is inserted into container 101 in a nesting fashion, and side structures 112 provide support legs or structure to maintain blender base 105 above blade 107, although this is not necessary to practice the invention.

FIG. 2 is a side elevation view of an embodiment of a portable blender system 100 contemplated by this invention, illustrating container 101, container lid 103, container handle 102, container bottom 104, blade 107, side structures 112, blender base 105, crank arm 106, clamp 110 and a support structure 111 which may be a table top or any other structure on which the blender may be mounted or secured.

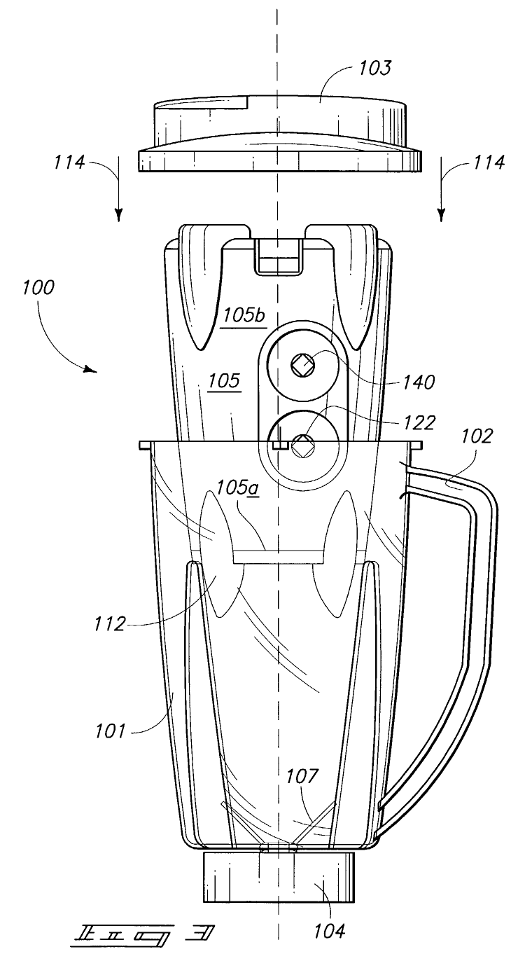

FIG. 3 is an exploded elevation view of an embodiment of this invention showing the insertion of blender base 105 into container 101. FIG. 3 illustrates container 101 with container handle 102, container bottom 104 and blade 107. Blender base 105 with top end 105a and bottom end 105b is being inserted upside-down into container 101 for storage and transportation, with the movement of blender base 105 being in the direction of arrows 114.

FIG. 3 also illustrates first crank axis 122 and second crank axis 140, which will be shown in later Figures to allow the crank arm to be operably attached to either one to provide two different blending speeds or to provide two different speeds for rotation of blade 107 when container 101 is operably attached to blender base 105. The portable blender system 100 illustrated in FIG. 3 may be configured in a couple of different ways, such as with blender base 105 fully insertable within container 101 such that container lid 103 may be attached to container to secure blender base 105 within an internal cavity in container 101. Arrows 114 illustrate the movement of containment lid 103 downward to attach to container 101.

There may also be embodiments of this invention where blender base 105 is not wholly inserted, but partially protrudes and containment lid 103 is not attachable to the container 101, but this is still within the scope of the invention as it provides a nesting feature or an insertion feature of the blender base 105 within container 101.

It will be noted that the container 101 illustrated in this Figure is transparent and therefore portions of blender base 105 can be seen through the transparent wall structure of container 101, as blender base 105 would be located within a container cavity formed by or defined by the side walls of the container 101.

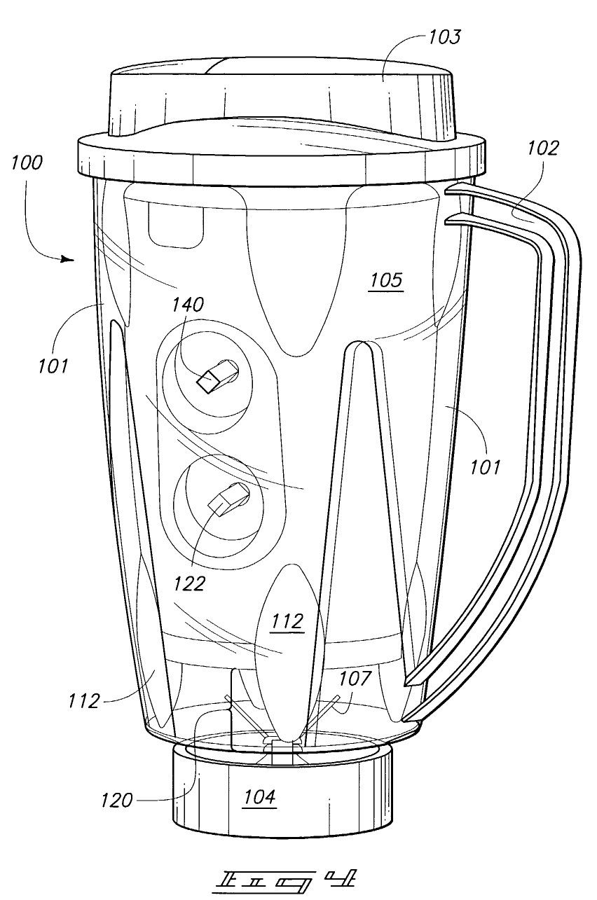

FIG. 4 is an elevation view of a portable blender system 100 contemplated by this invention, wherein blender base 105 has been fully inserted into, or nested within, container 101, and container lid 103 has been attached to the top end of container 101.

FIG. 4 further illustrates containment bottom 104, side structures 112 on blender base 105, first crank axis 122, second crank axis 140, containment handle 102 and blade 107. It will also be noted that FIG. 4 illustrates the use of side structures 112 to locate and support blender base 105 above blade 107 within container 101 by distance 120.

It will be noted that the crank axis 122 and 140 are shaped objected around which may be inserted into the hub of a crank arm such that when the crank arm is rotated, the crank axis are also rotated.

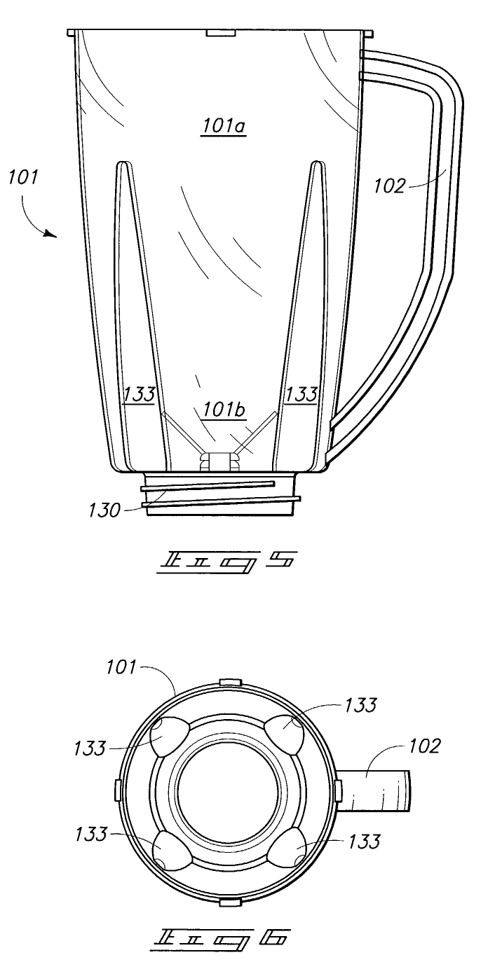

FIG. 5 is an elevation view of an embodiment of the container which may be utilized in this invention, illustrating container 101 with top end 101a and bottom end 101b, handle 102, threads 130 on bottom to facilitate attachment to the bottom (not shown in this figure), and container indentations 133 in the container 101.

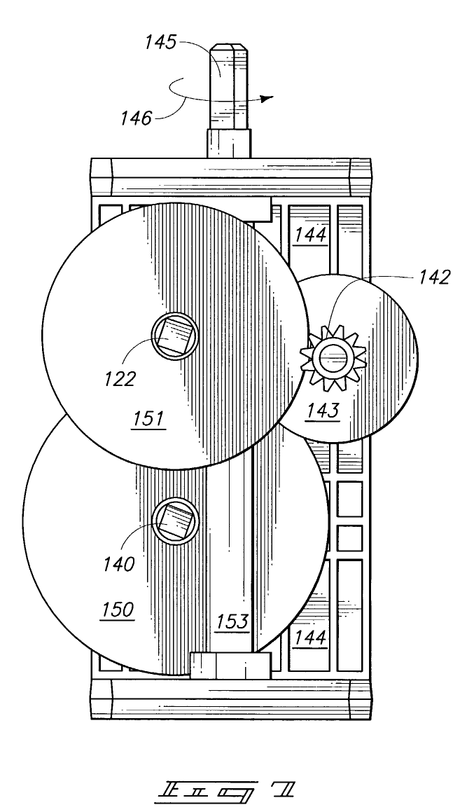

FIG. 6 is a top view of the container illustrated in FIG. 5, illustrating container, handle 102, and container indentations 133 in the container 101. The container indentations 133 may, but need not, be included in embodiments of the invention.

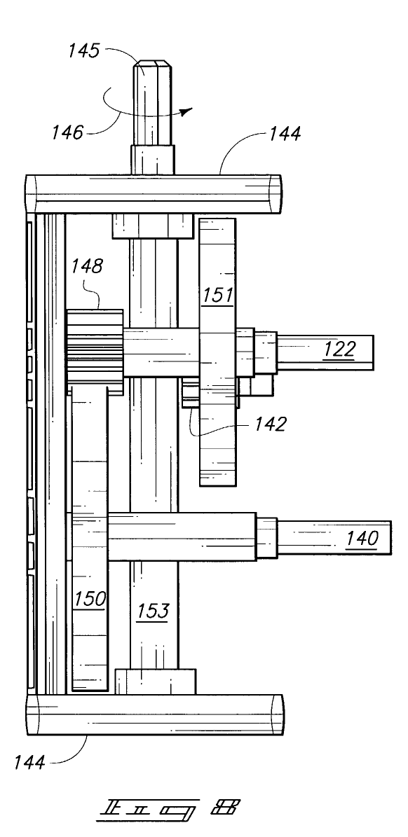

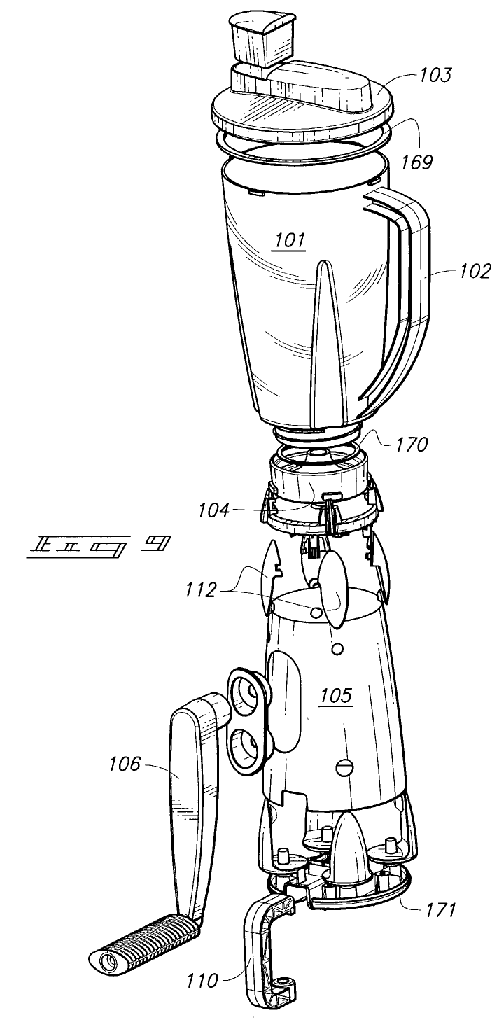

FIG. 7 illustrates an internal view of one embodiment of a drive system which may be utilized to transfer rotation from the hand crank ultimately to the blade 107 (shown in prior Figures). FIG. 7 shows first crank axis 122 attached to first crank axis gear 151 which provides a first speed of rotation. The first crank axis 122 when rotated by a crank handle would cause rotation of gear 142 and 143, which are operably attached to blade axis 145 and cause blade axis 145 to rotate in accordance with arrow 146, depending on the direction of the cranking of the hand crank and gearing system. Blade axis 145 has a lower end 153 which maybe rotatably mounted in any one of a number of different ways, such as by bushings or bearings, to base framework 144. Second crank axis 140 has second crank axis gear 150 and provides a second and faster speed of rotation when a hand crank is rotated at the same speed relative to first crank axis 122. The larger crank axis gear 150 interacts with other gearing to provide a faster rotation, as more fully illustrated in FIG. 8.

FIG. 8 is a side elevation view of the internal gearing or drive system illustrated in FIG. 7, and illustrates first crank axis 122, second crank axis 140, blade axis 145, rotation 146, first crank axis gear 151, second crank axis gear 150, gear 148 on first crank axis 122 which is operably attached to second crank axis gear 150 such that the second crank axis gear 150 provides faster rotation of gear 148 thereby causing faster rotation of blade axis 145 as illustrated in FIG. 8. Gear 142 is also shown in FIG. 8 which participates in the transmission of rotation from first crank axis 122 to lower part 153 of blade axis 145, thereby causing rotation of blade axis 145 and consequently blade within container 101 (shown in prior Figures).

FIG. 9 is a perspective exploded view of an embodiment of a portable blender system 100 contemplated by this invention, showing the numerous parts that may be utilized in a preferred embodiment. FIG. 9 illustrates container 101, container lid 103, container lid washer 169, container bottom washer 170, container bottom 104, container handle 102, blender base 105, blender base bottom 171, crank arm 106, side structures 112, and clamp 110,

As will be appreciated by those of reasonable skill in the art, there are numerous embodiments to this invention, and variations of elements and components which may be used, all within the scope of this invention.

One embodiment of this invention, for example, is a portable blender system which comprises: a container with a container cavity, a top side, a bottom side; a container lid attachable to the top side of the container; a container bottom attachable to the bottom side of the container; a blade operably attachable to the container such that when attached, the blade is positioned within the container cavity; a blender base with a base top side and a base bottom side, the blender base disposed to operably connect with and disconnect from the container bottom; a blade drive system within the blender base, the blade drive system including an input and an output, the blade drive system output being disposed to operably connect to the blade when the container bottom is operably connected with the blender base; and wherein the container cavity is sized and configured to receive and store the blender base.

Further embodiments of the foregoing may, but need not, further include: a hand crank attachable to the blade drive system input; an electric motor attached to the blade drive system input; a container cavity configured to wholly or partially receive and store the blender base. Other embodiments may be further: wherein the container lid is attachable to top side of the container when the base is stored within the container cavity; comprising a base clamp attachable to the blender base and disposed to clamp the blender base to another object when attached to the blender base; and/or wherein the blender base includes two or more side structures on the base top side, the two or more side structures configured to receive and restrain the container bottom when the container is operably attached to the blender base, and further configured to support the blender base above the blade when the blender base is stored in the container cavity. The side structures may also be made of a rubber or other less abrasive material to reduce or prevent the base from scratching or marring the interior walls of the container.

In yet another embodiment, a portable blending means may be provided which comprises: a containment means for containing material to be blended; a blending means for blending material to be blended and/or liquified, the blending means being operably attachable to the containment means such that when attached, the blending means is positioned within the containment means; a blender base with a means to operably connect with and disconnect from the containment means;

a drive means for driving the blending means and configured to drive the blending means when the blender base is operably connected to the containment means; and wherein the containment means is also configured to receive and store the blender base when the blender base is not operably connected to the containment means.

Further embodiments of the foregoing may, but need not, be further: comprising a hand crank means attachable to the drive means; comprising a motor means attached to the drive means; wherein the containment means is configured to wholly receive and store the blender base; wherein the containment means is configured to partially receive and store the blender base; and/or comprising a base securement means for securing the blender base to another object.

Further embodiments may include methods, such as a method for storing a blender comprising the following: providing a container with a container cavity; providing a blender base disposed to operably connect with and disconnect from the container bottom, the blender base being sized and configured to be inserted in the container cavity; and inserting the blender base into the container cavity.

A further method embodiment may be one which comprises placing a container lid over a top side of the container after the blender base has been inserted in the container cavity.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A portable blender system comprising:
a container with a container cavity, a top side, a bottom side, a container lid attachable to the top side of the container;
a container bottom attachable to the bottom side of the container;
a blade operably attachable to the container such that when attached, the blade is positioned within the container cavity;
a blender base with a base top side and a base bottom side, the blender base disposed to operably connect with and disconnect from the container bottom;
a blade drive system within the blender base, the blade drive system including an input and an output, the blade drive system output being disposed to operably connect to the blade when the container bottom is operably connected with the blender base; and
wherein the container cavity is sized and configured to receive and store the blender base.

2. A portable blender system as recited in claim 1, and further comprising a hand crank attachable to the blade drive system input.

3. A portable blender system as recited in claim 1, and further comprising an electric motor attached to the blade drive system input.

4. A portable blender system as recited in claim 1, and further wherein the container cavity is configured to wholly receive and store the blender base.

5. A portable blender system as recited in claim 1, and further wherein the container cavity is configured to partially receive and store the blender base.

6. A portable blender system as recited in claim 1, and further wherein the container lid is attachable to top side of the container when the base is stored within the container cavity.

7. A portable blender system as recited in claim 1, and further comprising a base clamp attachable to the blender base and disposed to clamp the blender base to another object when attached to the blender base.

8. A portable blender system as recited in claim 1, and wherein the blender base includes two or more side structures on the base top side, the two or more side structures configured to receive and restrain the container bottom when the container is operably attached to the blender base, and further configured to support the blender base above the blade when the blender base is stored in the container cavity.

9. A portable blending means comprising:
a containment means for containing material to be blended;
a blending means for blending material to be blended, the blending means being operably attachable to the containment means such that when attached, the blending means is positioned within the containment means;
a blender base with a means to operably connect with and disconnect from the containment means;
a drive means for driving the blending means and configured to drive the blending means when the blender base is operably connected to the containment means; and
wherein the containment means is also configured to receive and store the blender base when the blender base is not operably connected to the containment means.

10. A portable blending means as recited in claim 9, and further comprising a hand crank means attachable to the drive means.

11. A portable blending means as recited in claim 9, and further comprising a motor means attached to the drive means.

12. A portable blending means as recited in claim 9, and further wherein the containment means is configured to wholly receive and store the blender base.

13. A portable blending means as recited in claim 9, and further wherein the containment means is configured to partially receive and store the blender base.

14. A portable blending means as recited in claim 9, and further comprising a base securement means for securing the blender base to another object.

15. A method for storing a blender comprising the following:
providing a container with a container cavity;
providing a blender base disposed to operably connect with and disconnect from the container bottom, the blender base being sized and configured to be inserted in the container cavity; and
inserting the blender base into the container cavity.

16. A method for storing a blender as recited in claim 15, and further comprising placing a container lid over a top side of the container after the blender base has been inserted in the container cavity.
